(19) United States
(12) Patent Application Publication
(10) Pub. No.: US 2004/0252255 A1
(43) Pub. Date: Dec. 16, 2004

(54) Backlight, liquid crystal apparatus comprising such a backlight, and method of operating such an apparatus

(75) Inventor: Wiepke Folkerts, Eindhoven (NL)

Correspondence Address: PATENT LAW GROUP LLP, 2635 NORTH FIRST STREET, SUITE 223, SAN JOSE, CA, 95134, US

(73) Assignee: Lumileds Lighting U.S. LLC

(21) Appl. No.: 10/801,807

(22) Filed: Mar. 15, 2004

(30) Foreign Application Priority Data
Mar. 18, 2003 (EP) 03100688.5

(51) Int. Cl. G02F 1/1335

(52) U.S. Cl. 349/61

(57) ABSTRACT

A structure that may be used as a backlight for a liquid crystal display includes a light source and an optical waveguide. The optical waveguide is illuminated by the light source from an edge of the optical waveguide. The optical waveguide has a plurality of adjacent areas for illuminating corresponding parts of a liquid crystal panel. Each of the areas is provided with an independently controllable light source for illuminating the area.

### BACKGROUND

1. Field of Invention

The present invention relates to a backlight for a liquid crystal display, comprising a light source and an optical waveguide to be illuminated by said light source from an edge of said optical waveguide, the optical waveguide comprising a plurality of adjacent areas for illumination of corresponding parts of a liquid crystal panel.

The invention also relates to a liquid crystal display apparatus comprising such a backlight.

The invention also relates to a method of operating such a liquid crystal display apparatus wherein the optical waveguide comprises n areas and the liquid crystal panel comprises n parts that correspond to said n areas of the backlight, wherein n≧2.

2. Description of Related Art

U.S. patent application No. 2002/0003522 discloses a liquid crystal display method to reduce motional artifacts. In the method, a liquid crystal display apparatus is used which comprises a lighting part divided into a plurality of areas, the lighting/non-lighting of each of which can be controlled. For this purpose, either the method of direct illumination by providing electroluminescent illumination of each area is used, or the lighting of the areas is controlled by a liquid crystal shutter arranged between the backlight part and a liquid crystal panel. In the latter case, the shutter is e.g. divided into four light stripes. Each stripe may be made transmissive or non- transmissive for the light provided by the lighting part of the backlight. The light comes from one light source which is provided at an edge of the optical waveguide of the backlight in this case.

A drawback of this liquid crystal display apparatus is the fact that only one light source is used for all lighting parts at the same time. This implies that a more or less large portion of the light is lost when one or more of the shutter parts are non-transmissive. This results in an undesirably low energy efficiency.

An object of the invention is to provide a backlight for a liquid crystal display which has an improved energy efficiency.

### SUMMARY

In accordance with embodiments of the invention, a structure that may be used as a backlight for a liquid crystal display includes a light source and an optical waveguide. The optical waveguide is illuminated by the light source from an edge of the optical waveguide. The optical waveguide has a plurality of adjacent areas for illuminating corresponding parts of a liquid crystal panel. Each of the areas is provided with an independently controllable light source for illuminating the area.

### BRIEF DESCRIPTION OF THE DRAWINGS

The invention will now be elucidated by means of non-limiting examples, with reference to the drawings, in which:

FIGS. 1a and 1b are plan views of two embodiments of the backlight according to the invention;

FIG. 2 is a side elevation view of a liquid crystal display apparatus with the backlight of FIG. 1b; and

FIGS. 3a and 3b represent a control voltage for the light sources of the backlight of FIG. 1b.

### DETAILED DESCRIPTION

The presence of independently controllable light sources for each of the areas of the optical waveguide offers the possibility to illuminate only those areas which need to be illuminated. The backlight according to the invention ensures a minimum energy consumption. This offers great advantages in particular in the case of a method which is useful in reducing motion artifacts. This will be elucidated below.

Another advantage of the backlight according to the invention is that it is now possible to change the light source for a particular area of the optical waveguide, should this be required or desirable.

It is noted that the cited US patent application offers the possibility of separate light sources for each area of the optical waveguide. However, this renders it necessary to incorporate electroluminescent light sources in the backlight itself. This is disadvantageous in view of the complex method to manufacture such a backlight with built-in light sources. Furthermore, it is not possible to change the light sources afterwards. Instead, the backlight according to the invention is provided with a light source which illuminates the optical waveguide from a side thereof, the so-called edge-lit illumination technique. Since this is a much simpler and more versatile technique, this is the arrangement considered in this application.

Preferably, the plurality of areas consists of a first area and a second area having a common edge. This is the simplest configuration of the backlight according to the invention, however still having all the advantages thereof. Hence it can be manufactured and operated in the simplest possible way. Furthermore, if this backlight is operated such that only one of the areas is illuminated while the other one is dark, and vice versa, the average power consumption may be made more or less constant, while the power density is lower than in cases in which there are more than two areas.

Advantageously, the light source of each of the two areas is provided at an edge opposite said common edge. Not only does this offer even more design possibilities, but in particular it is now possible to provide the light sources at those edges that have the greatest dimension and/or the shortest distance to the common edge. This ensures that the power density within the light source can be kept as low as possible. Furthermore, it is now possible to cool the light source at more sides thereof.

Although the light source of the backlight according to the invention is not particularly limited, preferably at least one light source comprises a LED or a LED-based light source. LEDs have a very short rise and fall time, of the order of 10 ns. This ensures a very quick response to control signals, and a high average illuminance level. Furthermore, it is possible to divide the area to be lit into many small subareas, which are to be lit for only a very short time. Hence the rise and fall of the lighting should be very quick. Moreover, LEDs have a high energy efficiency, a high density of illumination, and a very long life, and they do not suffer much from being switched on and off many times.

The LED-based light sources include unpackaged LEDs and LEDs in various packages, such as single-package LEDs and stripline LEDs. The latter package offers a number of LEDs in line, in a transparent tube. Especially this type of LED-based light source is ideally suited for use in the backlight according to the invention. It is to be noted that throughout this application, the term LED also covers LED-based light sources.

However, other light sources, such as cathode fluorescent light sources, are not excluded. In many cases, in particular with lower switching frequencies etc., these kinds of light also sources provide a high density of illumination and have very compact dimensions.

The invention also relates to a liquid crystal display apparatus comprising a liquid crystal panel and a backlight therefor according to the invention. Such a liquid crystal display apparatus is a compact display means having the versatility and power economy that is provided by this invention.

Advantageously, the liquid crystal display apparatus further comprises first means for writing image data in the liquid crystal panel, and second means for independently controlling an illumination of the areas of the backlight. Although the presence of the first means and/or second means in the liquid crystal display apparatus is not necessary, it is advantageous to combine the functions in the apparatus in order to obtain a compact and more or less stand-alone unit. It is also possible, however, to control the liquid crystal panel and/or one or more light sources by other means not comprised in the display apparatus.

The first means for writing image data in the liquid crystal panel may, for example, consist of a control circuit connected to a plurality of scanning lines and signal lines perpendicular thereto. A plurality of pixels are arranged at the intersections of scanning lines and signal lines, corresponding to said intersections. Switching elements corresponding to the pixels are provided, which, on receiving an appropriate signal, will switch the transmittance of the liquid crystal(s) associated with each pixel.

The second means for independently controlling an illumination of the areas of the backlight may e.g. comprise a control circuit for controlling the light sources of the areas of the backlight. Advantageously, the first means and second means are controllable simultaneously. This will be elucidated further below.

The invention also relates to a method of operating a liquid crystal display apparatus according to the invention, wherein the optical waveguide comprises n areas, and the liquid crystal panel comprises n parts that correspond to said n areas of the backlight, wherein n≧2, the method comprising repeating the following steps: selecting one of the parts of the liquid crystal panel corresponding to one of the areas of the backlight; writing image data in said part, while said area is not illuminated and at least one of the remaining areas of the backlight is illuminated.

An advantage of the method according to the invention is that it offers a simple yet elegant method to reduce motion artifact problems when displaying moving images on the liquid crystal display apparatus. In a more general sense, the method according to the invention will be referred to as the “pseudo scanning backlight method”.

It is to be understood that selection of a part of the LCD panel and lighting of the corresponding area need not be strictly simultaneous actions. It is obvious, however, that they should follow each other more quickly than the writing action.

Please note that it is possible to write only in those parts of the panel, or even only that part, in which the image changes in any desired order. If the image in a certain part does not change, image data need not be rewritten to said part. Clearly, in this situation the advantage of the presence of multiple light sources is prominent, as the parts with the constant image may be illuminated continuously at an appropriate intensity, which is advantageous for the light source and the smoothness of the image. In many addressing modes, however, every consecutive part is addressed, whatever the change in the image. In that case, each part of the panel is selected consecutively and data are written in it, with the corresponding illumination of the areas corresponding to the other parts.

The method uses a liquid crystal display apparatus according to the invention, and the liquid crystal panel is divided into a number of parts that correspond to the different areas of the backlight. It is to be noted that this division need not be physical, but may be considered as grouping of pixels into certain subsets. In a comparable fashion, the backlight need not be divided into physically separated areas, but rather, the light sources used are able to illuminate predominantly one of the areas. The optical waveguide and the light sources are for this purpose designed such that each light source predominantly but not exclusively illuminates an area of the backlight and hence a corresponding part of the liquid crystal panel. The phrase “not exclusively” indicates that a smooth transition is allowed to prevent discontinuous lighting in the display.

Motion artifacts are a well-known problem in LCD (liquid crystal display)-based displays when they are used for displaying fast-moving images and/or video information. These motion artifacts are a result of the combination of three factors: (1) the mode of addressing the LCD pixels and their subsequent (slow) relaxation to the newly addressed state; (2) the backlighting of the LCD panel; (3) the properties of the human eye and the vision centre in the human brain.

In particular, continuous backlighting of the LCD panel causes the remnants of the first image to be still visible while a subsequent image is being written to the LCD panel, due to the slow relaxation of the LCD pixels. Furthermore, the human eye and brain are able to follow motion continuously, whereas an image of a movement on an LCD consists of a contiguous series of steady state-images.

The method according to the invention ensures that the part of the LCD panel that is being addressed is not illuminated. In other words, the lighting of the backlight areas and the addressing of the panel parts have a phase shift with respect to each other.

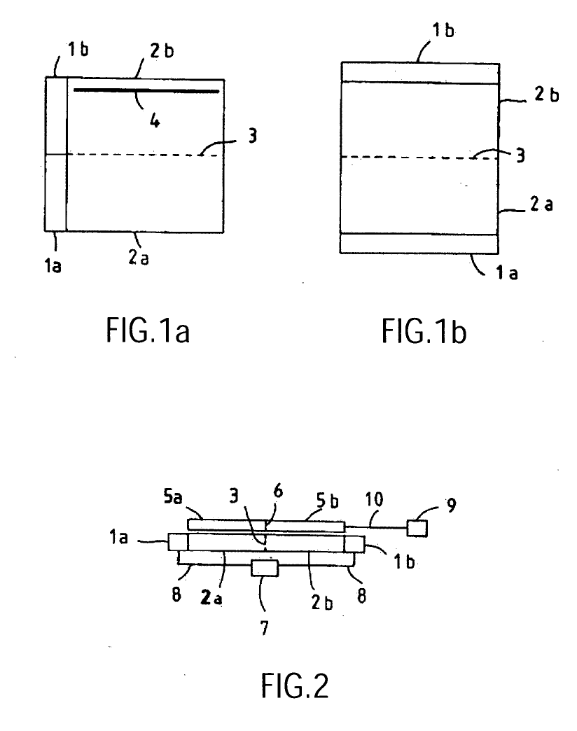

FIG. 1a shows a plan view of a backlight according to the invention, in which 1a and 1b are two light sources, 2a and 2b are two optical waveguide areas, which are divided by a line of division 3, represented by a dashed line.

Reference 4 represents the direction in which consecutive pixels of an LCD panel are to be addressed, when such a panel is to be used together with the backlight.

In the Figure, light sources 1a and 1b are shown as two separate units. In practice, they may be arranged as one larger unit having separately controllable parts, e.g. one large group of LEDs which may be controlled separately.

The light sources preferably have small dimensions, because in many applications the overall dimensions of the backlight are small. Hence, the light sources 1a and 1b advantageously comprise LEDs, for example white-light LEDs or groups of colored LEDs, e.g. with complementary colors. Advantageously, the LEDs are present in the form of stripline LEDs. Other light sources are not excluded, such as cathode fluorescent light sources, or electroluminescent light sources.

The light sources 1a and 1b are optically coupled to optical waveguide areas 2a and 2b. The optical waveguide may be any optical waveguide structure known in the art. In the drawing, the optical waveguide is divided into two parts 2a and 2b by means of a line of division 3. It is to be noted that this line need not correspond to any physical division but rather indicates an imaginary line which indicates the boundary between an area 2a which is predominantly lit by the light source 1a and an area 2b which is predominantly lit by the light source 1b.

Although the optical waveguide in the drawing is divided into two areas 2a and 2b, it is to be noted that the optical waveguide may in principle be divided into any number of mutually parallel areas. In that case a correspondingly larger number of light sources must be present. These light sources may be present, for example, in the form of a continuous row of light sources. Advantageously, the light sources of adjacent areas are present on opposite sides of the areas. This offers the advantage of improved cooling of the light sources.

The areas 2a and 2b are divided up according to the direction 4 in which an image is built up in an LCD panel to be used with the backlight. In this way it is ensured that each line of pixels in the panel which is being addressed is within one and the same area of the backlight.

FIG. 1b shows a plan view of a different arrangement of light sources 1a and 1b and optical waveguide areas 2a and 2b.

The optical waveguide areas 2a and 2b correspond to the arrangement according to FIG. 1a. However, the light sources 1a and 1b are now arranged on that edge of the respective optical waveguide part 2a, 2b, which is located opposite the common edge thereof, which is located at the line of division 3. An advantage of this arrangement is that the distance between the light sources 1a, 1b and the line of division, which indicates the maximum distance for the light to travel, is smaller than in the case according to FIG. 1a. This means that the luminous intensity of the light source may be lower, which offers a wider choice of light sources.

FIG. 2 shows a side elevation view of a liquid crystal display apparatus with a backlight according to the invention.

The apparatus shown consists of light sources 1a and 1b which can illuminate respective optical waveguide areas 2a and 2b, divided by line of division 3. The light sources are controlled by light source control means 7, connected to the respective light sources by means of first connection cable 8.

References 5a and 5b are a first and second part of a liquid crystal panel, divided by a second line of division 6. The panel parts 5a and 5b are addressed by panel addressing means 9, and connected thereto by a second connection cable 10.

The optical waveguide area 2a is to illuminate panel part 5a, and the optical waveguide area 2b is to illuminate panel part 5b. To ensure a good correspondence of illumination, the second line of division 6 should be aligned with line of division 3. It holds for both lines of division 3, 6 that they may be physical lines of division but may also be considered to be imaginary boundary lines in one optical waveguide or LCD panel.

The panel addressing means 9 serve to address the pixels or crystals of the display panel 5a, 5b. According to most addressing modes, pixels are addressed in the form of consecutive lines. Such lines preferably lie completely within one panel part. In that case, the lines are perpendicular to the plane of the drawing. Although the addressing mode by means of consecutive lines is preferred, other modes of addressing are not excluded, such as random addressing.

The light source control means 7 serve to operate light sources 1a and 1b independently. The means 7 may for this purpose be provided with an energy source, e.g. mains, and a switch. This switch may comprise electronic circuitry to enable synchronization of the switching action with the addressing of the panel. Preferably, the light source control means 7 and the panel addressing means 9 are coupled.

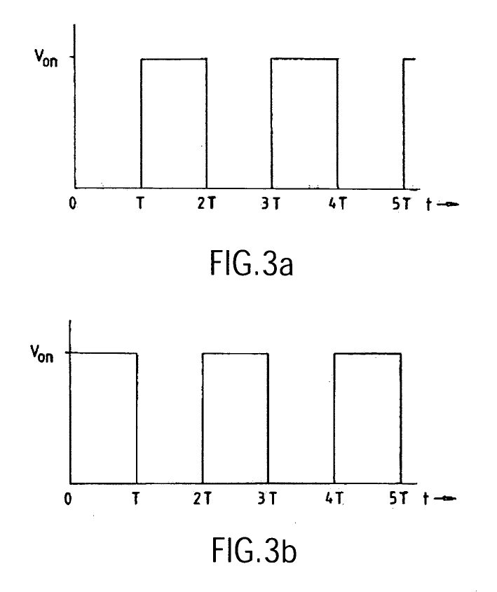

FIGS. 3a and 3b show control signals for the light sources 1a and 1b of the liquid crystal display apparatus according to FIG. 2.

The Figures show a voltage across the light sources. Herein Vₒₙ represents a voltage in a lit state, and 0 represents a non-lit state of the light sources. Depending on the working principle of the light sources, the voltage may be replaced by a current, etc.

FIG. 3a represents the signal across the light source 1a, whereas 3b represents the signal across the light source 1b, both in the same timeframe. In the timeframe between times t=0 and t=T, the light source 1a is off, whereas light source 1b is lit. During this time, according to the method of operating the apparatus according to the invention, the liquid crystal panel part 1a is being addressed. During the time between t=T and t=2T, the first light source 1a is lit whereas the second light source 2b is off. During said time, the liquid crystal panel part 5b is being addressed. From the time t=2T this cycle of alternating lighting of the light sources and addressing the panel parts is repeated with a period of 2T, with a phase shift of 180°, or (360°/number of areas) in general.

In this example of the method according to the invention, the number of light sources, areas and parts is 2. The method also works with higher numbers. The essence is that during addressing of a particular part of the liquid crystal display panel, the light source for illuminating said part is off, whereas all or some of the other parts of the liquid crystal display panel are lit by their respective light sources.

In FIGS. 3a and 3b, the duty cycle of each light source is 50%. It may be advantageous, however, to have a duty cycle between 40 and 60% because of the following. Liquid crystals have a non-zero relaxation time. In order to further improve the definition of the displayed image, it may be advantageous to illuminate the panel part only from the time that the liquid crystals have relaxed to their steady state. In most cases, e.g. with addressing frequencies of 60 Hz, a relaxation time of about 0.1 T will be sufficient, i.e. a minimum duty cycle of 40%. Although this means the occurrence of a completely black panel during 0.1 T twice during each cycle, the properties of human vision cause a smooth image to be perceived.

Likewise, if the relaxation time of the pixels is short enough not to pose any problems, or e.g. the images to be displayed show little or no motion, the duty cycle may be raised up to 60%. Since there is now some overlap between the lighting of both areas and panels, the resulting image is even smoother.

However, duty cycles of up to 50% are preferred, because in that case the peak power for operating the backlight is between 1 and 1.25 times the average power. This makes the power electronics for the backlight less complicated and cheaper than in the case of duty cycles of more than 50%.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is being claimed is:

1. A structure comprising:
a light source; and
an optical waveguide to be illuminated by said light source from an edge of said optical waveguide, the optical waveguide comprising a plurality of adjacent areas for illumination of corresponding parts of a liquid crystal panel;
wherein each of said areas is provided with an independently controllable light source for illuminating substantially said area.

2. The structure according to claim 1, wherein the plurality of areas consists of a first area and a second area having a common edge.

3. The structure according to claim 2, wherein the light source of each area is provided at an edge opposite said common edge.

4. The structure according to claim 1, wherein at least one light source comprises an LED.

5. The structure according to claim 1, wherein at least one light source comprises a cathode fluorescent light source.

6. A liquid crystal display apparatus comprising:
a liquid crystal panel; and
a backlight comprising:
a light source; and
an optical waveguide to be illuminated by said light source from an edge of said optical waveguide, the optical waveguide comprising a plurality of adjacent areas for illumination of corresponding parts of a liquid crystal panel;
wherein each of said areas is provided with an independently controllable light source for illuminating substantially said area.

7. The liquid crystal display apparatus according to claim 6, further comprising:
first means for writing image data in the liquid crystal panel; and
second means for independently controlling an illumination of the areas of the backlight.

8. A method of operating a liquid crystal display apparatus, the liquid crystal display apparatus comprising a liquid crystal panel and a backlight, the backlight comprising a light source and an optical waveguide to be illuminated by said light source from an edge of said optical waveguide, the optical waveguide comprising a plurality of adjacent areas for illumination of corresponding parts of a liquid crystal panel, wherein each of said areas is provided with an independently controllable light source for illuminating substantially said area, the optical waveguide comprises n areas, and the liquid crystal panel comprises n parts that correspond to said n areas of the backlight, n being greater than or equal to 2, the method comprising:
selecting one of the parts of the liquid crystal panel corresponding to one of the areas of the backlight;
writing image data in said part while said area is not illuminated and at least one of the remaining areas of the backlight is illuminated.

9. The method according to claim 8, wherein said selecting and said writing are repeated.

10. The method according to claim 8, wherein a backlight is selected having two areas of equal dimensions, and wherein the step of writing image data to one of the parts of the liquid crystal panel that corresponds to one of the areas requires a time T, such that during said step the other area of the backlight is illuminated during a time of between 0.8*T and T.
